(19) United States
(12) Patent Application Publication
(10) Pub. No.: US 2004/0118819 A1
(43) Pub. Date: Jun. 24, 2004

(54) Laser welding of nonferrous metals by using laser diodes and process gas

(76) Inventor: Wolfgang Danzer, Dorfen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/656,812

(22) Filed: Sep. 8, 2003

Related U.S. Application Data
(63) Continuation of application No. PCT/EP02/02474, filed on Mar. 6, 2002.

(30) Foreign Application Priority Data
Mar. 6, 2001 (DE) 101 10702.1
Mar. 6, 2001 (DE) 101 10701.3

(51) Int. Cl. B23K 26/20; B23K 26/12

(52) U.S. Cl. 219/121.64; 252/571

(57) ABSTRACT

The invention relates to a process gas for use during laser welding of nonferrous metallic workpieces with a laser beam focussed onto the workpiece to be welded and a laser diode as the laser beam source. According to the invention, the process gas contains at least carbon dioxide and/or oxygen. The process gas can, in addition to carbon dioxide and/or oxygen, also contain argon, nitrogen, helium and/or other precious gases.

### CROSS REFERENCE TO RELATED APPLICATIONS

This application is a continuation of International Patent Application No. PCT/EP02/02474, filed Mar. 6, 2002, designating the United States of America, and published in German as WO 02/070192, the entire disclosure of which is incorporated herein by reference. Priority is claimed based on Federal Republic of Germany patent application nos. DE 101 10 702.1 filed Mar. 6, 2001 and DE 101 10 701.3 filed Mar. 6, 2001.

### BACKGROUND AND SUMMARY OF THE INVENTION

The invention relates to a process gas for use during laser welding of nonferrous metallic workpieces with a laser beam focussed onto the workpiece to be welded, a laser diode being used as a laser beam source.

The invention also relates to a process for the laser welding of nonferrous metals, in which case a laser diode or several laser diodes are used as the laser beam source, at least one focussed laser beam being guided at the machining point to a workpiece surface to be machined, and a process gas flow being guided against the workpiece surface.

The characteristics of laser radiation, particularly the intensity and the good focussing capability, have had the result that nowadays layers are used in many material machining fields. Laser machining systems are often used in connection with computerized numerical controls (CNC). Corresponding laser machining systems are known in numerous variations.

Within the scope of the invention, a focussed laser beam is a laser beam which is essentially focussed on the workpiece surface. In addition to the predominantly used method with the laser radiation focussed on the workpiece surface, the invention can also be used in the case of the seldom used variant in which the radiation is not focussed exactly onto the workpiece surface.

In many methods of laser material machining, metallic and/or other material is heated to temperatures at which a reaction takes place with the enveloping gases. In many cases, commercial gases are therefore used in order to be able to carry out these material machining processes more effectively, fast and/or with an improved quality.

With respect to laser welding, it is known to use inert protective gases, such as helium or argon. Nitrogen is also sometimes used. In some cases, additions of active gas fractions, such a carbon dioxide, oxygen or hydrogen are also admixed to argon or nitrogen.

The tasks of the process gases during laser welding are multiple. The process gases determine, among other things, to a large extent, the economic efficiency, the quality and the process reliability of the laser welding.

Diode lasers as a laser beam source, in comparison to solid-state lasers (for example, Nd:YAG-lasers) and gas lasers (for example, CO₂ lasers) are of interest during laser welding because of a number of advantages: Diode lasers represent an extremely efficient artificial light source. They can be installed without great expenditures and, as a rule, can sufficiently operate with a conventional power supply as the energy supply. They are small and very compact. Further, they have a high efficiency (with 40 to 50% approximately five times higher than in the case of a conventional laser system). Finally, they have a long lifetime (normally at least 10,000 hours).

So far, diode lasers have not been successful in practice for laser welding of nonferrous metals. Insufficient laser welds occurred, particularly with low welding depths.

From our own published German Patent Documents DE 199 01 900 A 1 and DE 199 01 898 A1, it is known to use process gases for the laser welding of low-alloy steel types and zinc-coated steel types which contain either, in addition to helium and possibly argon, at least carbon dioxide with a fraction of up to 40% by volume or, in addition to helium and possibly argon, contain at least oxygen with a fraction of up to 30% by volume. The laser welding of nonferrous metals is not considered in detail in any of the patent publications.

Specifically during the laser welding of nonferrous metals, because of reflections of the radiation on the workpiece surface, frequently only a low coupling-in of energy takes place which, as a rule, does not permit a qualitatively high laser welding process using laser diodes as the laser beam source.

It is therefore an object of the invention to indicate a process gas and a process of the initially mentioned type which permit an improved laser welding of nonferrous metals by means of laser diodes. A high-quality laser welding process was to be provided. In particular, by means of the process gas, in addition to controlling and reducing the plasma, a laser weld was to be achieved at a high welding speed, with a deep penetration, of a high quality and with good seam geometries.

### DETAILED DESCRIPTION OF THE EMBODIMENTS

According to the invention, this object is achieved in that the process gas consists of 100% by volume carbon dioxide or of 100% by volume oxygen or of a

binary gas mixture with the constituents carbon dioxide and argon,

binary gas mixture with the constituents oxygen and argon,

binary gas mixture with the constituents carbon dioxide and nitrogen,

binary gas mixture with the constituents oxygen and nitrogen,

binary gas mixture with the constituents carbon dioxide and oxygen,

ternary gas mixture with the constituents carbon dioxide, argon and nitrogen,

ternary gas mixture with the constituents oxygen, argon and nitrogen, or

of a ternary gas mixture with the constituents carbon dioxide, argon and oxygen.

Within the scope of the invention, in contrast to ferrous metals and types of steel, nonferrous metals are particularly aluminum materials and alloys, magnesium materials and alloys, nickel base materials and alloys, copper materials and alloys and/or brass-containing materials.

Surprisingly, it has been found that carbon dioxide as well as oxygen can act as parameters influencing the welding process and result in a high-quality laser welding at a high welding speed. Whether this is based on the same operating mechanism in the case of carbon dioxide and oxygen, or whether it is based on different effects cannot be conclusively substantiated here.

It was observed that, if the process gas contains oxygen, the oxygen causes a change of the molten bath. Instead of the otherwise observed rotation of the molten bath in the upward direction (away from the machined workpiece surface), an unexpected rotation of the molten bath takes place in the downward direction; that is, in the direction of the workpiece surface to be machined. Presumably, the surface tension is reduced because of the oxygen from the process gas in the welding pool, which leads to the desired result of a high-quality laser welding process with a deep penetration.

Carbon dioxide in the process gas results in an extremely good coupling-in of energy. This is indicated by the fact that, with carbon dioxide in the process gas, surprisingly, laser welding processes can be carried out without any local overheating of the workpiece. This is possibly based on the dipole character of the carbon dioxide molecule in the process gas. Presumably, because of the carbon dioxide from the process gas, vibrations are generated in the workpiece, which lead to the desired result of a high-quality laser welding process. Whether here a conversion of the radiation energy to rotation and/or vibration energy is finally responsible for this improvement could not yet be conclusively clarified at this time.

A process gas containing carbon dioxide and oxygen will combine the effects and permit welding speeds which are just as high while the welds have a high quality.

The information concerning the volume fractions relates to wanted constituents of the process gas and not to unwanted or production-caused impurities. The carbon dioxide/the oxygen may therefore also contain normal impurities in the case of a fraction of 100% by volume. Advantageously, the fraction of carbon dioxide/oxygen in the process gas is at 15 and 90% by volume, preferably between 45 and 85% by volume, particularly preferably between 55 and 80% by volume. Advantageously, the process gas in this embodiment may also contain oxygen of a fraction of up to 50% by volume.

Advantageously, the fraction of oxygen in the process gas is at 15 and 0.90% by volume, preferably between 4.5 and 85% by volume, particularly preferably between 55 and 80% by volume. Advantageously, the process gas of this embodiment can also contain carbon dioxide of a fraction of up to 50% by volume.

In another embodiment, the process gas is fed in the direction of the normal line (at an angle of 90°) of the workpiece surface.

As an embodiment of the invention—particularly also for the above-mentioned binary and ternary gas mixtures respectively—laser diodes with a wavelength of from 700 to 1,300 nm, preferably of from 800 to 1,000 nm, are suitable for the laser welding. Thus, high-power laser diodes in the infrared range are preferred for the invention.

In an embodiment, particularly high-power laser diodes with a laser power of from 0.5 to 6 kW, preferably between 1 and 4 kW, can be used.

The invention will be described in detail in the following.

In tests, for example, during the laser welding of a workpiece made of AlMgSil with a thickness of 2 mm by means of a laser diode with a laser power of 3 KW, the surprising effect of the oxygen in the process gas according to the invention was confirmed. In this case, using a process gas fed concentrically to the laser beam at 90° onto the workpiece surface, the welding took place at a welding speed of 1 m/min. Here, on the one hand, as a comparative test according to the prior art, argon was fed as a process gas and, according to the invention, a process gas of oxygen was used under otherwise identical conditions. In comparison to the welding using argon, the advantages of oxygen according to the invention became clearly apparent. Thus, an analysis of micrographs proves that the welded surface existing in the thus obtained cut, in the case of the laser welding with argon, has a value of 0.93 mm², while in the section for the laser welding with oxygen, a surface of 7.76 mm² was obtained. Thus, the effect during laser welding could be increased more than eight times only by means of changing the process gas from argon to oxygen.

The invention as well as further details of the invention will be explained in detail in the following by means of test results shown in the figures.

### BRIEF DESCRIPTION OF THE DRAWINGS

FIG. 1 is a micrograph of a workpiece after a laser welding using argon;

FIG. 2 is a micrograph of a workpiece after a laser welding according to the invention using carbon dioxide.

### DETAILED DESCRIPTION OF THE DRAWINGS

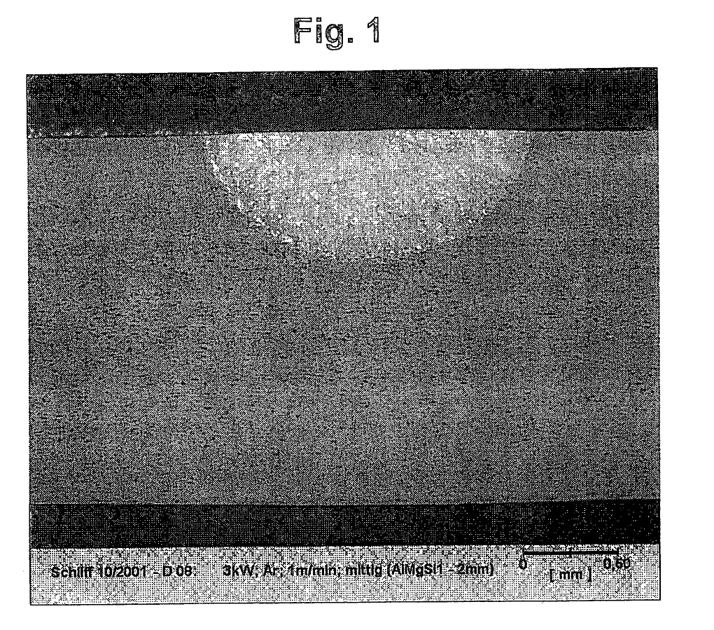

The micrograph of FIG. 1 shows a workpiece made of AlMgSil of a thickness of 2 mm, which was welded by means of a laser diode of a 3 KW laser power according to the prior art using a process gas of argon fed concentrically to the laser beam at 90° onto the workpiece surface at a welding speed of 1 m/min.

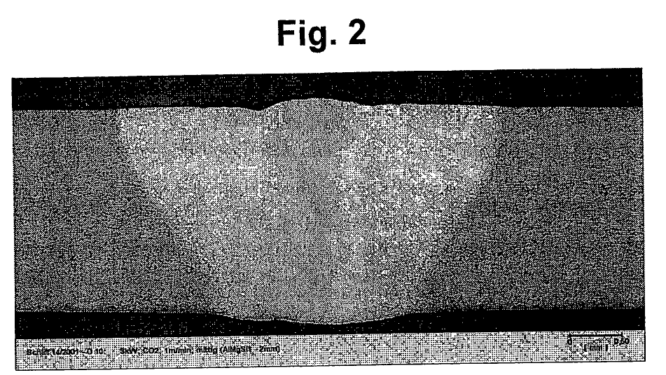

In comparison to the above, the micrograph of FIG. 2 shows an identical workpiece made of AlMgSil of a thickness of 2 mm which was welded according to the invention also by means of a laser diode of a 3 KW laser power using a process gas of carbon dioxide fed concentrically to the laser beam at 90° onto the workpiece surface at a welding speed of 1 m/min.

In comparison to the welding according to FIG. 1 using argon, the advantages of the invention are clearly apparent in FIG. 2, specifically that the coupling of energy into the workpiece to be welded could be increased significantly by means of the carbon dioxide process gas while otherwise the conditions were the same. Thus, the welded surface present in the micrograph, in the case of FIG. 1, has a value of 0.93 mm², while, in the micrograph according to FIG. 2, a surface of 5.75 mm² is obtained. The effect during the laser welding could therefore be increased approximately six times only by changing the process gas from argon to carbon dioxide.

What is claimed is:

1. A process gas for use during laser welding of nonferrous metallic workpieces with a laser beam focussed onto the workpiece to be welded, a laser diode being used as a laser beam source, comprising:
100% by volume carbon dioxide, or
100% by volume oxygen, or
a binary gas mixture of carbon dioxide and argon, or
a binary gas mixture of oxygen and argon, or
a binary gas mixture of carbon dioxide and nitrogen, or
a binary gas mixture of oxygen and nitrogen, or
a binary gas mixture of carbon dioxide and oxygen, or
a ternary gas mixture of carbon dioxide, argon and nitrogen, or
a ternary gas mixture of oxygen, argon and nitrogen, or
a ternary gas mixture of carbon dioxide, argon and oxygen.

2. A process gas according to claim 1, wherein the process gas contains between about 15% and about 90% by volume of carbon dioxide.

3. A process gas according to claim 1, wherein the process gas contains between about 45% and about 85% by volume of carbon dioxide.

4. A process gas according to claim 1, wherein the process gas contains between about 55% and about 80% by volume of carbon dioxide.

5. A process gas according to claim 1, comprising carbon dioxide and up to 50% by volume of oxygen.

6. A process gas according to claim 1, wherein the process gas contains between about 15% and about 90% by volume of oxygen.

7. A process gas according to claim 1, wherein the process gas contains between about 45% and 85% by volume of oxygen.

8. A process gas according to claim 1, wherein the process gas contains between about 55% and about 80% by volume of oxygen.

9. A process gas according to claim 1, comprising oxygen and up to 50% by volume of carbon dioxide.

10. A process for the laser welding of nonferrous metals, comprising:
providing one or more laser diodes as a laser beam source;
guiding at least one focussed laser beam to the workpiece surface to be machined; and
flowing a process gas against the workpiece surface, wherein the process gas comprises a process gas according to claim 1.

11. A process according to claim 10, wherein the process gas is flowed in the direction of the normal line (at an angle of 90°) to the workpiece surface.

12. A process according to claim 10, wherein the one or more laser diodes produce a wavelength of between about 700 nm and about 1,300 nm.

13. A process according to claim 10, wherein the one or more laser diodes produce a wavelength of between about 800 nm to about 1000 nm.

14. A process gas for use during laser welding of nonferrous metallic workpieces with a laser beam focussed onto the workpiece to be welded, a laser diode being used as a laser beam source, consisting essentially of:
100% by volume of carbon dioxide, or
100% by volume of oxygen, or
a binary gas mixture of carbon dioxide and argon, or
a binary gas mixture of oxygen and argon, or
a binary gas mixture of carbon dioxide and nitrogen, or
a binary gas mixture of oxygen and nitrogen, or
a binary gas mixture of carbon dioxide and oxygen, or
a ternary gas mixture of carbon dioxide, argon and nitrogen, or
a ternary gas mixture of oxygen, argon and nitrogen, or
a ternary gas mixture of carbon dioxide, argon and oxygen.
